(19) United States
(12) Patent Application Publication
(10) Pub. No.: US 2002/0016184 A1
(43) Pub. Date: Feb. 7, 2002

(54) Automatic method of managing network services

(75) Inventors: Hubert Helaine, Berkshire (GB); France Dervaux, Boulogne (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/918,501

(22) Filed: Aug. 1, 2001

(30) Foreign Application Priority Data
Aug. 3, 2000 (FR) 00 10 262

(51) Int. Cl. H04M 1/00

(52) U.S. Cl. 455/553; 455/465

(57) ABSTRACT

A mobile telephone is connected to a private base in the same way as it is connected to a mobile telephone network. The base is connected to another telephone network. The user employs the same interface, i.e. the telephone, to set parameters of services of either network. When the telephone is connected to it, the base provides an interface between the second network and requests sent via the telephone. A server of the second network can therefore process requests from the mobile telephone and the base can therefore manage acknowledgements from the server on-line or off-line and without interfering with a call.

### BACKGROUND OF THE INVENTION

1. Field of the invention

The present invention relates to an automatic method of managing network services. The field of the invention is that of telecommunications, and more particularly that of mobile or terrestrial telephony. The object of the invention is to enable a user who subscribes to a mobile telephone service and to a landline telephone service to access the associated services in a totally transparent manner, in other words to enable the user to access the terrestrial network or the mobile network from the same handset or terminal and in exactly the same way, whether it is the terrestrial network or the mobile network that is accessed.

2. Description of the prior art

The prior art includes terrestrial telephone networks and mobile telephone networks. Each kind of network offers a number of services. A service is a particular function offered to users by a telephone operator. Such functions include call forwarding, call barring, voicemail and other services provided by the operator. The services are accessed using a terminal connected to the network in question. The terminal in question then includes a keypad, and the various services offered by the operator are accessed by pressing a sequence of keys on the keypad.

Many mobile telephone and terrestrial telephone operators offer services but these services are not necessarily the same. Also, even if the services are exactly the same, they are not necessarily accessed in the same manner, or using the same access code. A user who has contracts with two different operators must therefore have two terminals connected to the respective operators. The user of the terrestrial network must know the procedures for accessing the terrestrial network services and the procedures for accessing the mobile telephone network services. As a general rule, the ergonomic features of stations providing access to a terrestrial network are less than the optimum, and as a result of this procedures are not intuitive and are difficult to memorize. As a general rule, access procedures consist in typing in numerical codes which are not easy to memorize. Users must also know the procedures for accessing the services of their second network. Over and above all of this, users are obliged to purchase two terminals.

Also known in the art are terminals able to make calls via a mobile telephone network and via a terrestrial telephone network. This constitutes an alternative to purchasing two phones. These terminals are known to be costly, however, because they consist of a combination of the other two terminals, even if they are in the same housing. Also, using this kind of terminal does not do away with the need to become familiar with the procedures for accessing the services offered by the terrestrial and mobile telephone networks.

The invention solves the above problems by connecting a mobile telephone, for example a GSM mobile telephone, to a private base that is itself connected to the network of a terrestrial telephone operator, for example to the public switched telephone network. The mobile telephone and the private base are connected in ways specific to the GSM. In one selected mode of operation the mobile telephone connects automatically to the private base as soon as it is within its range. The mobile telephone disconnects from the private base and reconnects to the mobile telephone network immediately it is no longer within range of the private base. When it is connected to the private base, the mobile telephone behaves like an access terminal to the switched telephone network. A mobile telephone user who requires to access services of either the mobile telephone or the terrestrial telephone network uses the same interface, i.e. the mobile telephone. If the mobile telephone is connected to the private base at the time, the mobile telephone sends the service request to the private base, which converts the request into a format of the terrestrial telephone network, and transmits the converted request to the terrestrial telephone network operator. The change of format is effected by means of a conversion table which in the example cited here is held in the private base.

The fixed network then sends an acknowledgement. For the acknowledgement to be received a call must have been set up, i.e. the telephone must be off-hook. It is the private telephone base that sets up the call and transmits the acknowledgement to the mobile telephone. The mobile telephone then emits a sound, for example in the form of a dual tone modulation frequency (DTMF) signal, matching what the user is used to hearing when using the terrestrial telephone network. In one embodiment the acknowledgement sound signal can be broadcast by the private base.

### SUMMARY OF THE INVENTION

The invention therefore provides an automatic network services management method in which:

a communication terminal of a first network is connected to a private base,

the private base is connected to a second network, and

a memory is structured to establish a correspondence between service codes of the first network and service codes of the second network.

The invention also provides a communication terminal and a private base for implementing the above method.

The invention will be better understood after reading the following description and examining the accompanying drawings. The drawings are provided exclusively by way of illustrative and nonlimiting example of the invention.

### BRIEF DESCRIPTION OF THE DRAWINGS

FIG. 1 shows how the invention is implemented.

FIG. 2 shows the steps of the method according to the invention.

FIG. 2a shows one possible frame structure for communication between the terminal and the private base.

FIG. 2b shows service management menus.

FIG. 2c shows one possible frame structure for communication between the private base and the terrestrial telephone network operator.

### DETAILED DESCRIPTION OF THE PREFERRED EMBODIMENT

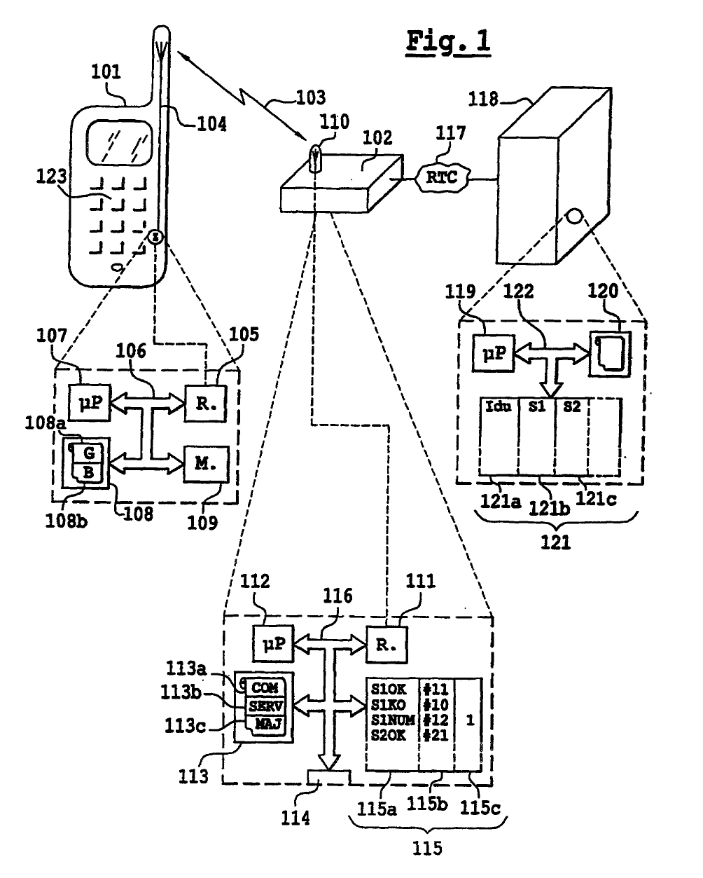

FIG. 1 shows a communication terminal 101. The terminal 101 is connected to a private base 102. In a preferred embodiment the terminal 101 is a mobile telephone. The mobile telephone 101 can operate in accordance with an existing or future mobile telephone standard. Information can be entered into the telephone 101 via a keypad, by speaking, or via any existing interface for entering information into a telephone. In this example the telephone 101 is a GSM telephone. In a preferred embodiment a connection 103 is set up between the telephone 101 and the base 102 using modulation and radio communication systems present in the telephone 101. Thus the telephone 101 can be connected to the base 102 or to a base station of a public mobile telephone network using the same systems. Thus, using systems that it already includes, the telephone 101 can communicate with the base 102 using a carrier close to but outside the GSM frequency bands. The carrier can easily be generated by the circuitry used for the GSM frequency bands. The other possibility is to send in the GSM band but at sufficiently low power not to interfere with the operation of the base stations of a public GSM telephone network. In all cases the send power must be relatively low anyway, because the range of the base 102 is restricted to a few hundred meters. The base 102 is therefore not picked up by the base stations of a public mobile telephone network.

The telephone 101 therefore includes an antenna 104 connected to a circuit 105 for producing and receiving radio signals. The circuit 105 is also connected to a bus 106. The circuit 105 receives via the bus 106 numerical information telling it what radio signals it must produce to be sent via the antenna 104. The circuit 105 also receives via the antenna 104 radio signals that it demodulates and places in a memory of the circuit 105. The memory can be read via the bus 106.

Throughout this description a bus is considered to be a set of wires or tracks for conveying signals corresponding to address signals, data signals, command signals, interrupt signals or clock signals. In the preceding sentence the “or” is not exclusive.

The telephone 101 also includes a microprocessor 107, a program memory 108 and a data memory 109. The items 107 through 109 are also connected to the bus 106. The memory 108 contains instruction codes that command the microprocessor 107. The memory 108 also contains instruction codes for executing GSM tasks and instruction codes enabling the terminal 101 to communicate with the base 102. In a preferred embodiment, which is also the best embodiment, different instruction codes command the microprocessor 107 according to whether the telephone 101 is in communication with a public mobile telephone network or with the base 102. However, it is the same circuit 105 that is used to produce radio signals in order to communicate with the public mobile telephone network or with the base 102. The memory 108 therefore has at least two areas, including an area 108a containing instruction codes commanding the microprocessor when it is in GSM mode and an area 108b containing instruction codes commanding the microprocessor when it is connected to the base 102.

The memory 109 contains a description of the status of the various parameters and services of the telephone 101 and of the network to which it is connected. That description is structured and can be consulted in the form of a menu.

FIG. 1 also shows that the base 102 includes an antenna 110 connected to a circuit 111 for producing and receiving radio signals. The operation of the circuit 111 is similar to that of the circuit 105. The base 102 further includes a microprocessor 112, a program memory 113, a connection port 114 and a correspondence memory 115. The items 111 through 115 are connected to a bus 116.

The microprocessor 112 is commanded by instruction codes contained in the memory 113. The memory 113 includes a plurality of areas. One area 113a contains instruction codes for commanding the microprocessor 112 when the base 102 is in communication with the terminal 101. The memory 113 also includes an area 113b containing instruction codes commanding the microprocessor 112 when it is processing requests relating to the processing of services. A service is a function offered by a telephone operator. The more frequent services include call forwarding and voicemail. The memory 113 also includes an area 113c which commands the microprocessor 112 when it is updating the correspondence memory 115.

The port 114 enables the base 102 to be connected to a terrestrial telephone network 117. In a preferred embodiment the network 117 can be the public switched telephone network.

The memory 115 is structured in the form of a table. The table 115 includes at least two columns and in a preferred embodiment includes three columns. A first column 115a corresponds to service codes sent by the terminal 101 and received by the base 102. A second column 115b establishes the correspondence between the codes from column 115a and codes sent by the base 102 to a terrestrial telephone operator 118 via the network 117. A third column 115c includes a list of parameters received by the base at the same time as a service code. The list corresponds to the parameters that may be useful to the operator 118 for processing the service code.

Each line of the table 115 corresponds to a service code. In the FIG. 1 example, the first line of the table 115 contains the code S1OK. The correspondence relationship is defined between that code and the code #11 and there is no item corresponding to the code S1OK in the third column. This means that if the base 102 receives the code S1OK it transmits the code #11 to the operator with no parameters. The third line of the table 115 shows that the code S1NUM corresponds to the code #12 with the parameter 1. This means that if the table 102 receives the code S1NUM with a list of parameters, it transmits the code #12 to the operator with the first parameter from the list that it receives at the same time.

FIG. 1 also shows that the operator 118 is in fact reduced to a server. This reduction does not conform to reality, but assists a good understanding of the invention. The server 118 includes a microprocessor 119, a program memory 120 and a user management memory 121. The items 119 through 121 are connected by a bus 122. The memory 120 includes instruction codes that command the microprocessor 119. The memory 121 is structured in the form of a table. The table 121 includes a first column 121a that corresponds to an identifier of a user of the network managed by the operator 118. The column 121b includes a description of the status of the first service and the column 121c corresponds to the description of the status of a second service. The table 121 therefore includes at least as many columns as there are services offered by the operator 118. Each line of the table 121 corresponds to a user who has entered into a contract with the operator 118. In practice the table 121 is merely an extract from a much larger table managed by the operator 118 for its users. In practice the table can have a different structure provided that it is possible to access information on services put into corresponding relationship with users. The server 118 is connected to the network 117.

Note that in the following description, if an action is attributed to a microprocessor, that action is effected by said microprocessor at the command of instruction codes contained in a memory.

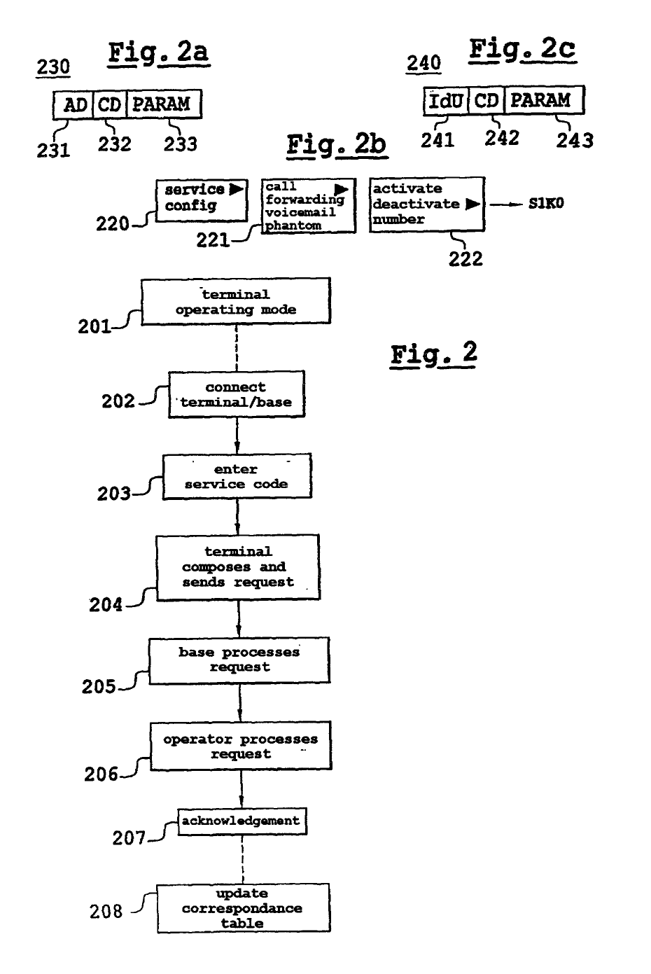

FIG. 2 shows a preliminary step 201 in which the mode of operation of the terminal is chosen. In step 201 the user of the telephone 101 uses a keypad 123 of the telephone to scroll through menus and chose the mode in which the telephone 101 is to operate. The modes of operation of interest here include how the terminal 101 behaves when it comes into range of the base 102. The user of the telephone 101 can choose to retain priority for the public mobile telephone network for outgoing calls made from the terminal 101, even if the terminal 101 is within range of the base 102. This means that all transmissions by the terminal 101 are addressed to the public mobile telephone network. The other solution which is of interest in the context of this invention consists of choosing the mode in which the telephone 101 connects to the base 102 as soon as it comes within its range. The range of the base 102 is generally a few hundred meters, generally 300 meters. The range of the base 102 is generally defined by the transmission power of the base 102. The mode of operation is stored in a memory that is read when the telephone 101 comes into range of the base 102. That memory is updated by scrolling through the menus of the telephone 101, i.e. in fact by pressing a sequence of keys.

Next is a step 202 of connecting the terminal 101 to the base 102. FIG. 1 makes it clear that the telephone 101 connects to the base 102 or to the GSM network, not shown, in exactly the same way. In a different embodiment of the invention the telephone 101 could connect to the base 102 in a specific way, for example in accordance with the DECT standard. In step 202 the telephone 101 is considered to have been configured to connect to the base 102 when it comes within its range. When the telephone 101 comes within the range of the base 102, the microprocessor is commanded by the instruction codes contained in the area 108b.The microprocessor 107 being initially commanded by the instruction codes from the area 102a, the area 102a includes instruction codes for determining the position of the telephone 101 relative to the base 102. The microprocessor 107 then sets the parameters of the circuit 105 so that it ignores all messages sent by the public mobile telephone network. Similarly, the microprocessor 107 sets the parameters of the circuit 105 so that it sends at a power level sufficient for it to be received by the base 102, but not sufficient to interfere with the public telephone network. In a different embodiment the telephone 101 and the base 102 communicate at a carrier frequency close to the GSM band, so that the carrier frequency can be produced by the circuit 105 but is outside the GSM band, so that it does not interfere with the public mobile telephone network.

Next is a step 203 for entering service codes.

The user has two options in step 203, either to use the configuration menus or to enter the service code directly. A user who chooses to use the menus uses the keys of the keypad 123 to scroll through the menus. FIG. 2b shows one example of a possible menu. The user presses a predetermined key on the keypad 123 to access a main menu 220 of the telephone 101. The menu 220 offers two options, either managing services or managing the configuration of the telephone 101. The user uses cursor keys of the terminal 101 to select the chosen service. The user validates that choice by pressing the validation key, which goes to a services management menu 221. The menu 221 offers several options, for example managing call forwarding, voicemail or the phantom mode. The user selects call forwarding management and is taken to a call forwarding management menu 222. The user uses the cursor keys to select the required action from the menu 222, in this example activating, deactivating or setting the parameters of the call forwarding number. In this example the user chooses deactivation, which corresponds to the code S1KO.

The user can also choose to enter the service code directly. In this case he enters the service code using the keypad 123. He can enter the code S1KO directly, if he knows the service code specific to deactivating call forwarding for the terminal 101. The user can also enter directly the call forwarding deactivation code corresponding to the operator 118 to which the base 102 is connected. In this case the user enters #10 directly.

Next is a step 204 in which the terminal 101 composes and sends a request. In this step the microprocessor 107 composes a request 230 at the command of instruction codes from the memory 108b. The request 230 includes at least one field 231 corresponding to an identifier of the base 102, a field 232 containing the service code and a field 233 possibly containing parameters corresponding to the service code. The identifier 231 of the base can be in any format. A numerical key coded on several bytes is feasible, for example. The existence of this field is justified on the assumption that the telephone 101 would be within range of a plurality of bases of the same type as the base 102. It would then be necessary for the bases to know to which one the telephone 101 is connected.

In this example the field 232 contains the code S1KO because the user chose to enter the service code in menu mode; otherwise it contains what the user enters. User input is confirmed by a predetermined key. In this example the field 233 does not contain any parameter because the action that the user wishes to carry out does not call for the entry of parameters. If the user had chosen to set the parameters of the call forwarding number, the parameter field 233 would have contained the number to which the user wishes calls to be forwarded.

When the request has been composed in a working memory, the microprocessor 107 transmits the request to the circuit 105, which converts it into a radio signal sent via the antenna 104 and received by the base 102 via the connection 103.

Next is a step 205 for the base 102 to process the request. The antenna 110 picks up the radio signals sent by the terminal 101 and the circuit 111 converts the radio signals into digital signals that the microprocessor 112 can process. At the command of instruction codes from the memory 113a, the microprocessor 112 registers, by means of the content of the field 231, the fact that it has just received a message concerning a service code addressed to the base 102. The microprocessor 112 is then at the command of instruction codes contained in the services management area 113b. At the command of instruction codes contained in the area 113b, the microprocessor 112 therefore extracts the field 232 from the request that it has received. Once it has extracted that field, it scans the column 115a to find the code contained in the field 232.

If during this scanning the microprocessor finds the code 232 in the column 115a it composes a request 240; the request 240 includes a field identifying the user to the operator 118, a field 242 containing a service code, and a field 243 containing parameters associated with the code 242. The microprocessor writes in the field 242 the code from the column 115b corresponding to the code 232 in the column 115a. The field 241 contains an identifier of the user in relation to the operator 118. That identifier can be the user's terrestrial line number. In practice the identifier is stored in the memory of the base 102. The memory for storing the identifier has its parameters set during installation of the base 102 provided by the operator 118.

If the microprocessor 112 fails to identify the code 232 in the column 115a it writes the code 232 directly in the field 242.

The microprocessor then consults the column 115c corresponding to the code 232 in the column 115a. It extracts from the field 233 the parameters that are cited in column 115c and places them in the field 243. In this example the instruction code is that from the second line, i.e. the code S1KO that corresponds to the code #10 and that does not require any parameters. The field 242 therefore contains the code #10 and the field 243 is empty.

If the base 102 had received a request with the field 232 containing the code S1, then the microprocessor would have composed another request with the field 242 containing the code #12 and would have extracted the first parameter from the field 233 to place it in the field 243.

If during scanning of the column 115a the microprocessor 112 has not been able to match the content of the field 232 with an element from said column, then the microprocessor 112 retranscribes the fields 242, respectively 243, the fields 232, respectively 242.

When the request 240 has been composed, the microprocessor 112 transmits it to the port 114; the request 240 then passes through the network 117 to the operator 118. Next is a step 206 for the operator to process the request.

In step 206 the microprocessor 119 looks for the content of the field 241 in the column 121a. Once it has found it, it looks in the corresponding line for the content of the field 242. It then updates the corresponding field. This means that the microprocessor 119 updates the table 121 as a function of requests that the server 118 receives. The microprocessor can therefore scan the table 115 to find out how it must behave when faced with an incoming call for a user present in the table 115. If call forwarding is activated, then incoming calls are redirected to another number, also recorded in the table 115. Call forwarding is deactivated in the present example. This means that calls to the terrestrial number of the subscriber will not be redirected to a number other than his own number. Once this update has been effected, the operator 118 sends an acknowledgement. This is the acknowledgement step 207.

As a general rule, the transmission of information over a fixed telephone network, such as the network 117, necessitates an off-hook condition, i.e. line seizure. The base 102 is responsible for line seizure, which enables it to send the request 240 and to receive the acknowledgement from the operator 118. Once the base 102 has received the acknowledgement, it can then go off-hook. This operation is totally transparent for the user of the telephone 101. Once the base 102 has received the acknowledgement from the operator 118, it releases the line. The acknowledgement is generally transmitted in the form of a DTMF code. It is then possible for the base 102 itself to broadcast the sound corresponding to the DTMF code, or for it to transmit to the terminal 101 a request for the latter itself to emit the sound corresponding to the DTMF code. In a preferred embodiment the second solution is chosen, namely a request for the terminal to emit a sound corresponding to the DTMF code is transmitted by the base 102. This is because the user of the terminal 101 is not always within hearing distance of the base 102.

If the service request must be sent when the user is on line, the connection between the user and the other party is interrupted during the transmission of the signals necessary for routing the request and the acknowledgement. The interruptions are very short and do not interfere with communication between the user and the other party.

Note that, even in the mode of operation entailing automatic connection to the base 102, the user of the telephone 101 can expressly specify on the terminal 101 sending a request to their public mobile telephone network in order to modify said services on said network. If the user of the telephone 101 is not in the mode of operation entailing automatic connection to the base 102, requests sent by the terminal 101 for modification of services are addressed to the public mobile telephone network to which the terminal is connected at the time. This is true even if the terminal 101 is within range of the base 102.

FIG. 2 also shows the step 108 of updating the correspondence table 15. There are various options for step 208. A first option is for the memory 115 to be contained in a microchip card, in which case the microchip card is installed when the base 102 is delivered. The memory of the microchip card is then updated in the factory as a function of the services and the operators to which the user for whom the microchip card is intended has chosen to subscribe. It is possible to effect all possible combinations between an existing mobile telephone operator and an existing terrestrial telephone operator. The table 115 can therefore allow for all these possibilities.

Another option, cumulative with the first option, is for the base to call the server 118 periodically. The server 118 then has information enabling it to know with which mobile telephone operator the user of the base calling it has a contract. It then sends information enabling the base 102 to update the memory 115 itself. The call can be made periodically and in accordance with parameters set by the user of the base 102.

A third option, cumulative with the preceding two options, is to use any available method to notify the user of the base 102 that he must update his memory 115. Such notification can be in the form of a new microchip card to be inserted into the base 102 or a message indicating that the user must initiate the updating of the memory 115. The message can be sent by post, for example. Initiation is then an option in the menu of the telephone 101. The base 102 then connects to the operator 118 and updates the memory 115.

In a variant of the invention, the memory 115 is in the telephone 101. In this instance the processing initially effected by the base 102 is then done by the telephone 101. This saves composing the frame 230. The telephone 101 composes the frame 240 and transmits it to the base 102. The base 102 relays the frame 240 to the operator 118. The base 102 then manages the acknowledgement; this is step 207. The table 115 can then be updated in the same way as if it were in the base 102.

In a different embodiment of the invention, and regardless of where the table 115 is located, the table can be updated via a connection to the first network. The telephone then stores the new version of the table 115 in a temporary memory, and then updates the table of the base 102 as a function of that new version. If the table is in the telephone 101, the temporary memory can be dispensed with and the table updated directly.

Over and above a method of the above kind, the present invention also provides, in particular, a communication terminal and a private base adapted to implement the method.

There is claimed:

1. An automatic network services management method in which:
a communication terminal of a first network is connected to a private base,
said private base is connected to a second network, and
a memory is structured to establish a correspondence between service codes of said first network and service codes of said second network.

2. The method claimed in claim 1 wherein said correspondence memory is in said communication terminal.

3. The method claimed in claim 1 wherein said correspondence memory is in said private base.

4. The method claimed in claim 3 wherein:
a request corresponding to a service is composed from said communication terminal,
said request is sent from said communication terminal and received at said private base,
said request is updated in said private base as a function of said correspondence memory, and
said request is sent to said second network and is received by an operator managing said services of said second network.

5. The method claimed in claim 4 wherein, if said correspondence memory contains no match to said request sent by said communication terminal, said request is transmitted without formatting to an operator managing said services of said second network.

6. The method claimed in claim 4 wherein an acknowledgement is received at said communication terminal after processing of said request by an operator managing said services of said second network.

7. The method claimed in claim 4 wherein an acknowledgement is received at said private base after processing of said request by an operator managing said services of said second network.

8. The method claimed in claim 1 wherein said correspondence memory is updated during a call between said private base and an operator of said second network.

9. The method claimed in claim 1 wherein said correspondence memory is updated during a call between said communication terminal and an operator of said first network.

10. The method claimed in claim 8 wherein said correspondence memory is updated automatically and periodically.

11. The method claimed in claim 8 wherein said updating is triggered by a user.

12. The method claimed in claim 1 wherein said first network is a mobile telephone network.

13. The method claimed in claim 1 wherein said second network is a terrestrial telephone network.

14. The method claimed in claim 1 wherein said mobile communication terminal is automatically connected to said private base when said terminal is within range of said base.

15. A communication terminal adapted to implement an automatic network services management method in which:
a communication terminal of a first network is connected to a private base,
said private base is connected to a second network, and
a memory is structured to establish a correspondence between service codes of said first network and service codes of said second network.

16. A private base adapted to implement an automatic network services management method in which:
a communication terminal of a first network is connected to a private base,
said private base is connected to a second network, and
a memory is structured to establish a correspondence between service codes of said first network and service codes of said second network.
